(19) United States
(12) Patent Application Publication
(10) Pub. No.: US 2012/0149521 A1
(43) Pub. Date: Jun. 14, 2012

(54) DRIVE DEVICE FOR ENTRANCE AND EXIT DEVICES

(75) Inventors: Hans-Georg Brauer, Kaufungen (DE); Andreas Pellegrini, Wabern (DE); Andreas Schunke, Hardegsen (DE); Dirk Muller, Kaufungen (DE)

(73) Assignee: GEBR. BODE GMBH & CO.KG, Kassel (DE)

(21) Appl. No.: 12/741,863

(22) PCT Filed: Nov. 7, 2008
(86) PCT No.: PCT/EP2008/065177

§ 371 Date: Aug. 16, 2010

(30) Foreign Application Priority Data
Nov. 9, 2007 (DE) 20 2007 015 770.3

(51) Int. Cl. F16H 1/28; F16H 1/02

(52) U.S. Cl. 475/156; 74/413; 74/411.5

(57) ABSTRACT

The invention relates to a drive device for entrance and exit devices for public transport vehicles, having a drive, the drive comprising an electric drive motor and a reduction gear, wherein a drive element of the drive motor is coupled to an input element of the reduction gear, and an output element of the reduction gear is coupled to the entrance/exit devices. The drive device is characterized in that it is constructed as a compact drive, wherein the electric drive motor and the reduction gear are arranged axially one behind the other inside a tube-shaped housing, it has a non-self-locking reduction gear, and has an additional locking device for locking the drive.

### TECHNICAL FIELD

The invention relates to a drive apparatus for boarding/deboarding devices for public transport vehicles with a drive system comprising an electric drive motor and a reduction gear unit, where a driven element of the drive motor is connected to an input element of the reduction gear unit and an output element of the reduction gear unit is coupled to the boarding/deboarding devices.

### BACKGROUND

Such boarding/deboarding device include in particular passenger doors, boarding ramps, retractable steps and the like on public transport vehicles and are known per se. One problem that occurs is that, in an emergency, a passenger door must be opened manually or also that a retractable step or a boarding ramp is to be brought into a certain position manually, and that this is made more difficult by the fact that the drive apparatus has such a strong self-locking action because of the high reduction ratio of the gear that manual movement is made extremely difficult. Therefore, it is often necessary to uncouple the gear in the case of an emergency. The means required therefor entail a corresponding effort in production and assembly as well as increased costs. In addition, conventional drive apparatuses require considerable space, which presents a problem in particular where the available space is limited.

### BRIEF SUMMARY

The invention provides a drive apparatus with the features specified in the introduction in such a way that manual actuation is possible in the case of an emergency. In particular, the drive apparatus is supposed to have a compact structure and require little space. Production and installation are supposed to be possible in a cost-effective manner.

According to the invention, a generic drive apparatus is provided including
a compact drive structure, by the electric drive motor and the reduction gear unit being disposed axially one behind the other within a tubular housing,
a non-self-locking reduction gear unit,
an additional blocking device for blocking the drive system.

The basic concept of the invention lies in providing a non-self-locking drive or non-self-locking reduction gear unit, and to provide the blocking action not by means of the drive or the gear unit, but by means of a blocking device. Because of the weak self-locking action, the manual actuation of the boarding/deboarding devices is always ensured in the case of an emergency; only the blocking effect of the blocking device must be canceled. This results in a high degree of safety.

Since no self-locking action of the drive or the gear unit is provided, an additional block of the drive is an absolute requirement. This block can be effected by means of an additional braking device, which, when it is not energized, causes a mechanical lock of the drive. This brake can be released electrically or manually by hand in order to uncouple the drive and thus enable electrical and/or manual operation. The manual release of the brake can take place via a known spring-loaded brake with manual release, wherein the manual release of the brake can be used for a mechanical emergency release device. Such brakes are known by the term “low active brake”. However, any other suitable blocking device can be used alternatively. For example, the brake may act on the driven shaft of the drive motor by means of a spring force and may be electromagnetically releasable.

According to the invention, a brake may even be dispensed with entirely as a blocking device if the drive motor can be short-circuited. Thus, the door can be kept locked and be prevented from moving by means of the short circuit torque of the drive motor. This function is always guaranteed, even is the vehicle is standing and is not in operation. If the emergency release is actuated, the connection between the two contacts of the motor is interrupted preferably via a mechanical switch, the short circuit torque is canceled and the door can easily be opened by hand without any problems. The self-locking action of the door is thus canceled by a simple disconnection of the positive or the negative line of the motor. The locking action is always present in the non-energized state of the motor, that is, a power failure does not have any altering influence on it. In the case of power failure or electronic system failure, the emergency release can always be carried out by actuating the short circuit switch. It is possible to lock the boarding/deboarding device again, in particular a door, after the interruption of the short circuit by switching back the switch.

According to the invention, the short circuit switch preferably works directly without any auxiliary power and thus, also in the case of a disused vehicle or of a power interruption.

The advantages of using such a short circuit switch on the one hand lie in the reduction of the required components for the emergency release, on the other hand, the short circuit switch can be positioned at any ergonomically favorable place; the installation of the otherwise usual Bowden cables or pneumatic lines can be dispensed with.

According to the invention, a combination of a lock on the basis of a short circuit and the use of a brake or mechanical lock is also possible. This can be the case especially if the short circuit torque is insufficient for locking the door securely.

The switchable short circuit can advantageously be ensured by special windings of the motor windings which are exclusively provided for the purpose of generating the short circuit. An enhanced braking action or locking action can also be achieved by special windings.

A planetary gear unit is well suited as a gear unit.

Moreover, the output element of the reduction gear unit can be connected with a lift-and-turn unit, a component known per se, which is used in particular in outward-swinging doors. By lifting the door, the door leaf is connected in a positive fit with the door portal by means of lock strikers.

The entire drive apparatus according to the invention is preferably configured as a compact drive system in which the electric drive motor and the reduction gear unit are disposed axially one behind the other within a tubular housing. This slim constructional shape of the drive permits its integration in a visually attractive manner, for example, anywhere on the door rotation post, which is also configured to be tubular. Thus, placing the drive according to the structural conditions in the vehicle and the connection possibilities is possible in a simple way, which creates constructional space for other components in the area for door driving systems that were used so far, e.g. in the area of the roof.

Moreover, a rotary travel detection can be provided according to the invention. Advantageously, this is carried out by means of an incremental or an absolute value encoder directly on the motor shaft of the drive motor or on a driven shaft for the boarding/deboarding device. For example, if the drive apparatus is used for a passenger door, the rotary travel detection can take place via the driven shaft for a rotation post connection.

Detection of the rotary travel via the driven shaft has the advantage that possible material fractures in the drive can be recognized and signaled in the case the door opens inadvertently.

### BRIEF DESCRIPTION OF THE DRAWING

Two exemplary embodiments for a drive apparatus according to the invention are being explained below with reference to the attached drawing.

FIG. 1 illustrates a drive apparatus in an exemplary embodiment of the invention.

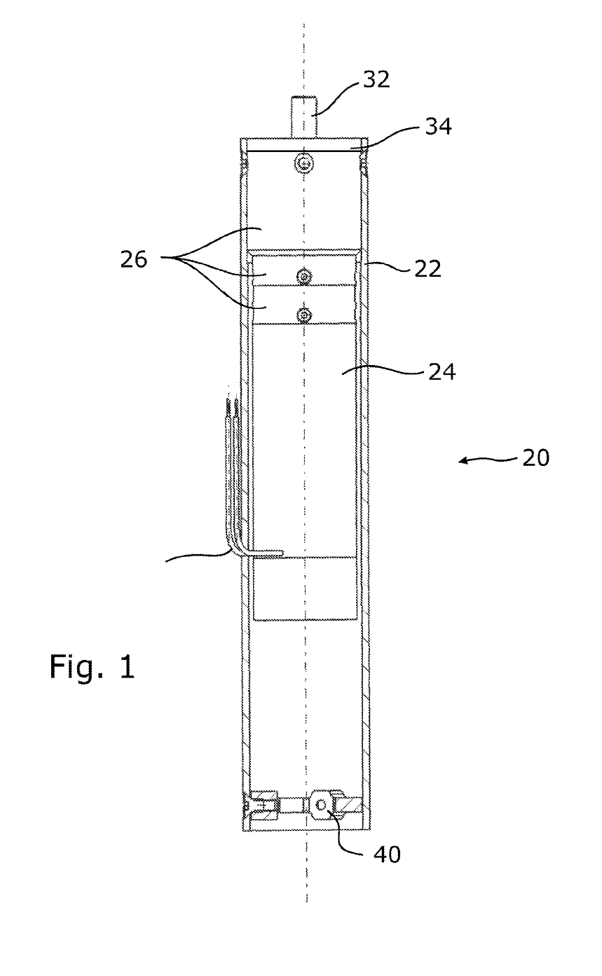

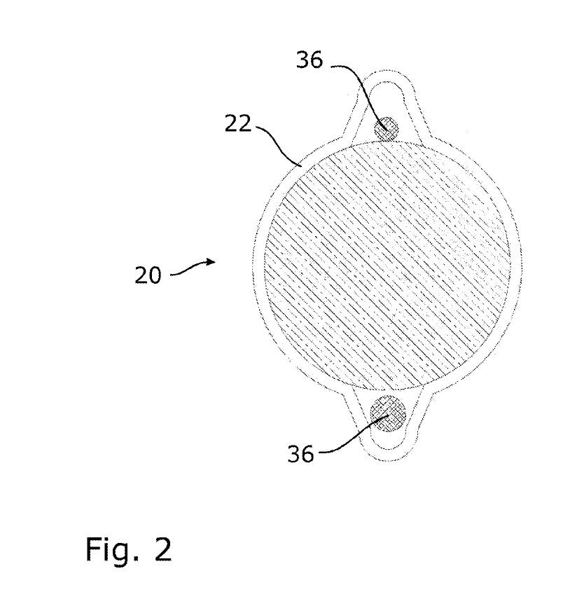

### DETAILED DESCRIPTION

The only FIGURE shows a drive apparatus 20 configured as a compact drive, for example for a passenger door, in which an electric drive motor 24 and a reduction gear unit 26, which is shown as a three-part planetary gear unit, are disposed in the axial direction one behind the other within a slim housing 22 formed in a tubular manner. The drive motor 24 is followed by a brake 28, which is also accommodated within the housing 22 and which can be configured as a “low active brake” that engages under spring force and can be released electromagnetically and mechanically. Electrical connectors 30 of the drive motor 24 are also shown. The reduction gear unit 26 is configured to be non-self-locking.

Preferably, the drive apparatus 20 is accommodated in a rotation post which is not shown.

A driven element (which is not visible) of the drive motor 24 is connected with an input element (which also is not visible) of the reduction gear unit 26, the output element 32 of which is connected with an input element or an actuating device of a boarding/deboarding device not shown. The output element 32 can be connected, for example, to a known lift-and-turn unit, the output element of which is connected with the actuating apparatuses for the boarding/deboarding device, for example, a passenger door.

Moreover, a device 34, by means of which the rotary travel of the drive unit (20) can be detected, is disposed on the output element 32 of the reduction gear unit 26. This device for rotary travel detection can be configured, for example, as an absolute value encoder, but also as an incremental value encoder.

Moreover, a torque support 40 is provided for coupling the drive apparatus 20, which is connected with the vehicle with components that are not shown.

All electrical connector elements 30 and mechanical connector elements 31 (Bowden cable for manually unlocking the brake) are disposed within the housing 22.

Moreover, a sensor, e.g. a proximity switch, for detecting the lift of the lift-and-turn unit can be disposed in the area of the output element 32.

The torque generated by the drive motor 24 is transmitted via the reduction gear unit 26 onto the output element 32. In case of an emergency, only the brake 28 must be released, after which the manual actuation of the passenger door is readily possible due to the lack of self-locking action of the reduction gear unit 26.

Instead of or in addition to the brake 28, a short circuit device can also be provided for locking, which short-circuits the motor windings of the drive motor 24 for locking.

The invention is not limited to the exemplary embodiment described, but also includes other appropriate possible embodiments in the scope of protection of the applicable claims.

According to the invention, the drive apparatus can also be used advantageously in combination with a so-called high active brake. Such a brake is also known by the term armature force brake and is active in the energized state, and the door is fixed in this position. For this purpose, the boarding door is provided with an external locking device for locking the entrance in a vehicle that is parked for a longer period of time. This can take place, for example, by means of a remote-controlled central locking system. In a vehicle that is parked for a shorter period of time, the door can be locked by means of the supply voltage being switched off in a delayed manner, without any external lock. In this case, the brake continues to be energized for this period of time.

Such a combination of the described drive apparatus with a high active brake has the great advantage that a mechanical emergency release, for example via the Bowden cable, is not required anymore. Emergency release is effected by means of an opening contact in the armature control line for the brake. The emergency release can be reset in a centralized or decentralized manner with simple means. For example, a decentralized reset of the emergency release can be carried out via an external relay setting.

1.-12. (canceled)

13. Electrically driven rotary post for public transport vehicles, comprising:
a drive apparatus having an electric drive motor and a reduction gear unit, wherein a driven element of the drive motor is coupled to an input element of the reduction gear unit and an output element of the reduction gear unit is coupled to boarding/deboarding devices,
wherein the drive apparatus comprises a compact drive structure, in which the electric drive motor and the reduction gear unit are disposed axially one behind the other within a tubular housing, a non-self-locking reduction gear unit and an additional blocking device for blocking the drive, and
wherein the drive apparatus is disposed within the rotary post.

14. Drive apparatus according to claim 13, wherein the blocking device is formed by a brake.

15. Drive apparatus according to claim 13, wherein the blocking device is formed by a switchable short circuit of the drive motor.

16. Drive apparatus according to claim 15, wherein a mechanical emergency switch for disengaging the short circuit is provided.

17. Drive apparatus according to claim 15, wherein an element connected in parallel to the short circuit is provided, which prevents an inadvertent canceling of the short circuit during travel.

18. Drive apparatus according to claim 16, wherein an element connected in parallel to the short circuit is provided, which prevents an inadvertent canceling of the short circuit during travel.

19. Drive apparatus according to claim 14, wherein the brake is configured as a brake that acts on the driven element of the drive motor by spring force and can be released electromagnetically and mechanically.

20. Drive apparatus according to claim 13, wherein the reduction gear unit is configured as a planetary gear unit.

21. Drive apparatus according to claim 13, further comprising a rotary travel detection device for detecting the rotary travel of the drive unit.

22. Drive apparatus according to claim 21, wherein the output element is a driven shaft, a rotary travel of which is detected by the rotary travel detection device.

23. Drive apparatus according to claim 13, wherein the output element is connected to a lift-and-turn unit.

24. Drive apparatus according to claim 13, wherein all electrical connector elements and mechanical connector elements are disposed within the drive unit.
